(19) United States
(12) Patent Application Publication
(10) Pub. No.: US 2024/0187263 A1
(43) Pub. Date: Jun. 6, 2024

(54) SECURE AND EFFICIENT DISTRIBUTION OF SMART CONTRACT APPLICATION BINARY INTERFACES AND ADDRESSES

(71) Applicant: VMware LLC, Palo Alto, CA (US)

(72) Inventors: Bala Siva Sai Akhil Malepati, Sunnyvale, CA (US); Ram Krishnan, Cupertino, CA (US)

(21) Appl. No.: 18/061,294

(22) Filed: Dec. 2, 2022

(51) Int. Cl. H04L 9/00; H04L 9/08; H04L 9/32

(52) U.S. Cl. CPC H04L 9/50; H04L 9/0827; H04L 9/3247

(57) ABSTRACT

Techniques for securely and efficiently distributing the application binary interface (ABI) and address of a smart contract to end-users are provided. In one set of embodiments, these techniques include persisting the ABI with the smart contract on a blockchain, signing, by the replicas maintaining the blockchain, the smart contract address using a threshold signature scheme, and providing the signed smart contract address to the end-users. With this general approach, the end-users can verify that the smart contract address is authentic by validating its signature. Further, the end-users can directly retrieve the ABI from the blockchain on an as-needed basis using the verified address, thereby ensuring the integrity of the ABI and avoiding the need for the end-users to store and manage it themselves.

### BACKGROUND

Unless specifically indicated herein, the approaches described in this section should not be construed as prior art to the claims of the present application and are not admitted to be prior art by inclusion in this section.

A blockchain is a distributed ledger of data that is maintained by a peer-to-peer computer network, referred to as a blockchain network. Each node of the blockchain network, known as a replica, holds an identical copy of the blockchain and receives client requests to add transaction records to the blockchain in the form of blocks. To ensure that the replicas' respective copies of the blockchain remain consistent, the blockchain network employs a consensus protocol that controls the order in which the replicas process client requests (and thus, the order in which blocks are added to the blockchain). The specific consensus protocol employed, as well as other implementation details and features of the blockchain network, are determined by the network's blockchain technology platform. Examples of well-known blockchain technology platforms include Ethereum and Hyperledger Fabric. Many blockchain technology platforms specify the use of a Byzantine fault tolerant (BFT) consensus protocol, which allows for correct network operation in the face of up to f Byzantine replicas (i.e., faulty/corrupted replicas that can exhibit arbitrary behavior).

A smart contract is a software program that can be deployed on a blockchain and is associated with an application binary interface (ABI) and an address. The ABI defines the methods that are exposed by the smart contract and callable by client applications, referred to as decentralized applications or “dapps.” The address can be understood as the deployed location of the smart contract on the blockchain. Once a smart contract is deployed by a blockchain network operator, the operator typically distributes the smart contract's ABI and address to developers (i.e., end-users) that wish to access the smart contract via their dapps. This enables the developers to program their dapps to find the smart contract on the blockchain and invoke the methods of its ABI.

Currently, the foregoing distribution process is handled via an offline, point-to-point communication mechanism. For example, the operator may email the smart contract's ABI and address to each end-user. However, there are several challenges with this approach. First, point-to-point communication mechanisms like email are insecure and thus susceptible to attacks. For instance, an attacker may swap the smart contract address included in an email with the address of the attacker's own malicious smart contract. Second, because the ABI is distributed by the operator a single time, each end-user must take steps to store and manage the ABI via, e.g., a source code management (SCM) system or some other system so that it can be accessed as needed by the end-user's dapp. This responsibility can become burdensome, particularly if the end-user needs to manage a large number of ABIs.

### BRIEF DESCRIPTION OF THE DRAWINGS

FIG. 1 depicts an example environment and workflow for deploying a smart contract and distributing the smart contract's ABI and address to an end-user.

FIG. 2 depicts an improved smart contract ABI and address distribution workflow according to certain embodiments.

FIG. 3 depicts a smart contract and ABI deployment flowchart according to certain embodiments.

FIG. 4 depicts a smart contract address distribution and verification flowchart according to certain embodiments.

FIG. 5 depicts an ABI retrieval and consumption flowchart according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to techniques for distributing the ABI and address of a smart contract to end-users in a secure and efficient manner. In one set of embodiments, these techniques include (1) persisting the ABI with the smart contract on a blockchain, (2) signing, by the replicas maintaining the blockchain, the smart contract address using a threshold signature scheme, and (3) providing the signed smart contract address to the end-users. With this general approach, the end-users can verify that the smart contract address is authentic by validating its digital signature. Further, the end-users can directly retrieve the ABI from the blockchain on an as-needed basis using the verified address, thereby ensuring the integrity of the ABI and avoiding the need for the end-users to store and manage it themselves.

### 1. Example Environment and Solution Overview

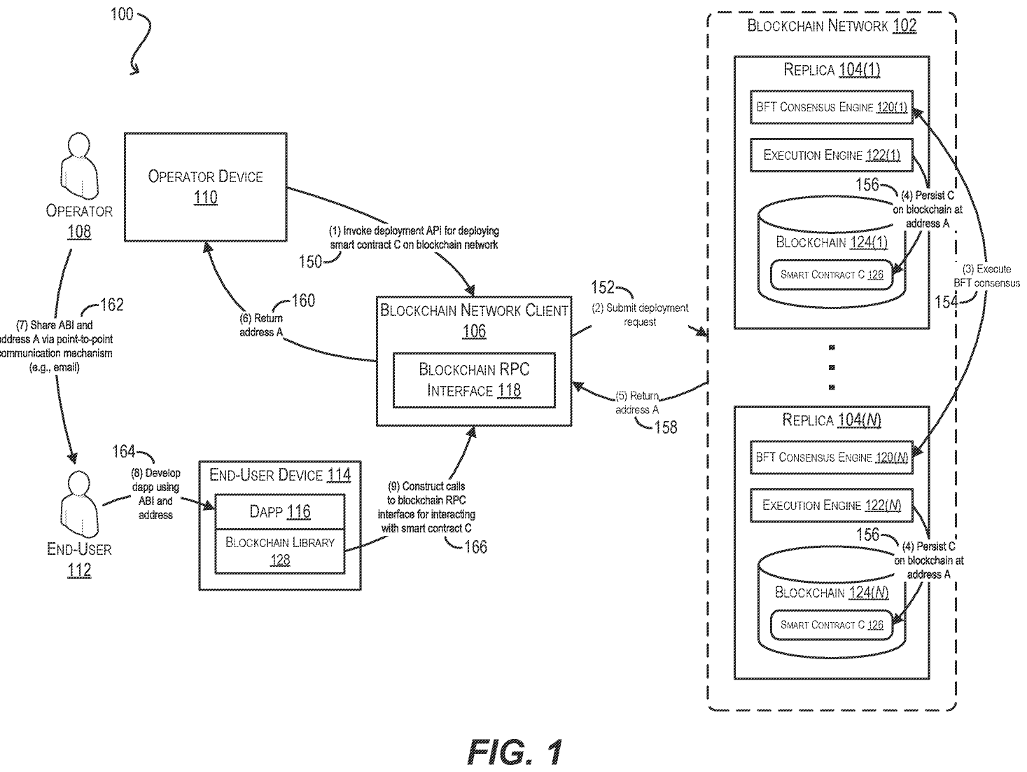

To provide context for the embodiments described herein, FIG. 1 depicts an example environment 100 and a conventional workflow that may be executed within this environment for deploying a smart contract C and distributing the smart contract's ABI and address to an end-user. As shown, environment 100 includes a blockchain network 102 comprising N replicas 104(1)-(N), a blockchain network client 106, a blockchain network operator 108 operating an operator device 110, and an end-user 112 operating an end-user device 114. End-user 112 is assumed to be a developer or administrator of a decentralized application (dapp) 116 that would like to access the functionality provided by smart contract C. For example, smart contract C may implement methods pertaining to the creation and management of non-fungible tokens (NFTs) and dapp 116 may be a front-end NFT wallet application.

Starting with step (1) of the workflow (reference numeral 150), operator 108 invokes, via operator device 110, a deployment API for deploying smart contract C on blockchain network 102. This deployment API is part of a blockchain remote procedure call (RPC) interface 118 exposed by blockchain network client 106 that allows external entities to interact with blockchain network 102. For example, in the scenario where blockchain network 102 implements the Ethereum blockchain technology platform, blockchain RPC interface 118 may be the EthRPC interface. The invocation of the deployment API at step (1) includes a compiled (i.e., binary) version of smart contract C and the smart contract's ABI (in the form of a JavaScript Object Notation (JSON) file).

At step (2) (reference numeral 152), blockchain network client 106 passes the deployment API invocation as a client request to replicas 104(1)-(N) of blockchain network 102. In response, replicas 104(1)-(N) agree upon an execution sequence number for processing the client request via a BFT consensus protocol implemented by the replicas' BFT consensus engines 120(1)-(N) (step (3); reference numeral 154). As noted previously, a BFT consensus protocol can tolerate up to f faulty replicas. Accordingly, the coordination at step (2) guarantees that at least N−f replicas will agree on the same execution sequence number for the client request.

Once the agreed-upon execution sequence number is reached, an execution engine 122 of each non-faulty replica 104 independently executes the client request by persisting smart contract C on the replica's blockchain 124 at an address A, shown via reference numeral 126 (step (4); reference numeral 156). Address A, which is the deployed address of smart contract C, is then returned to operator device 110 (and thus, operator 108) through blockchain network client 106 (steps (5) and (6); reference numerals 158 and 160).

Upon receiving address A, operator 108 shares it with end-user 112 via an offline, point-to-point communication mechanism such as email (step (7); reference numeral 162). Finally, end-user 112 uses the ABI and smart contract address received from operator 108 to develop dapp 116, thereby enabling the dapp to interact with deployed smart contract C and invoke its methods (step (8); reference numeral 164). In the example of FIG. 1, dapp 116 interacts with smart contract C via a language-specific blockchain library 128, which constructs appropriate calls to blockchain RPC interface 118 for invoking the smart contract's methods (step (9); reference numeral 166). For example, if dapp 116 is programmed in Java and blockchain RPC interface 118 is the EthRPC interface, blockchain library 128 will be a Java-based library that is configured to construct EthRPC calls. In other embodiments, dapp 116 may send calls directly to blockchain RPC interface 118 without the help of library 128.

As mentioned in the Background section, there are a couple of issues with the conventional workflow shown FIG. 1. First, the use of a point-to-point communication mechanism such as email for sharing the ABI and address of smart contract C between operator 108 and end-user 112 at step (7) is insecure. For example, an attacker may intercept the communication and change the ABI and/or address in a manner that is difficult or impossible for end-user 112 to detect. Second, upon receiving the ABI, end-user 112 must store and maintain the ABI via an SCM system or the like so that dapp 116 can access it as needed. This can become a significant pain point for end-user 112, particularly if the ABI is large in size and/or the end-user needs to maintain multiple ABIs.

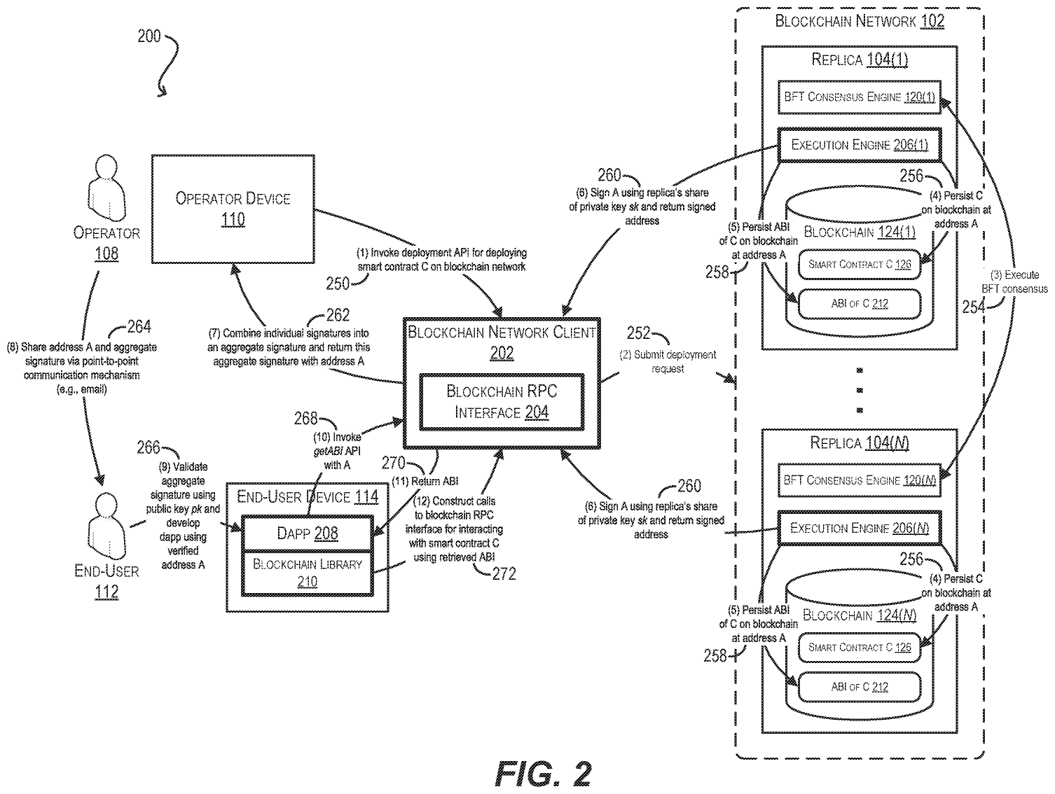

To address the foregoing and other related issues, FIG. 2 depicts a modified version of environment 100 of FIG. 1 (i.e., environment 200) and an improved workflow for distributing the ABI and address of smart contract C to end-user 112 within this environment according to certain embodiments. The modified entities in environment 200 include a modified blockchain network client 202 and blockchain RPC interface 204, a modified execution engine 206 in each replica 104, a modified dapp 208, and a modified blockchain library 210 (shown via bolded outlines).

Steps (1)-(3) (reference numerals 250-254) of the workflow of FIG. 2 are similar or identical to the corresponding steps shown in FIG. 1. However, at steps (4) and (5) (reference numerals 256 and 258), as part of executing the client request for deploying smart contract C, modified execution engine 206 of each replica 104 can persist both the smart contract and its ABI on the replica's blockchain 124 at address A (rather than solely persisting the smart contract). The storage of the smart contract ABI on the blockchain is shown via reference numeral 212. In addition, modified execution engine 204 can sign address A using a portion (i.e., share) of a private key sk that is uniquely assigned to, and only known by, that specific replica and can provide the signed address to modified blockchain network client 202 (step (6); reference numeral 260). These per-replica shares of private key sk are denoted herein as sk₁, . . . , sk_{N} and are generated via a (t, N) threshold signature scheme where t=f.

At step (7) (reference numeral 262), upon receiving signed addresses from at least f+1 replicas, modified blockchain network client 202 can combine the individual signatures in those signed addresses into an aggregate signature in accordance with the (t, N) threshold signature scheme and can return the aggregate signature with address A to operator device 110/operator 108. Operator 108 can then share address A and the aggregate signature with end-user 112 via an offline, point-to-point communication mechanism that is similar or identical to the one used at step (6) of FIG. 1 (e.g., email) (step (8); reference numeral 264).

Upon receiving address A and the aggregate signature, end-user 112 can verify (via, e.g., end-user device 114) whether the aggregate signature is valid using a public key pk that is the public key counterpart of private key sk and, assuming this verification is successful, can use the verified smart contract address A to develop modified dapp 208, thereby enabling the dapp to interact with deployed smart contract C and invoke its methods (step (9); reference numeral 266). This dapp is different from the version shown in FIG. 1 because it can provide just the address of smart contract C to modified blockchain library 210 (not shown), which can in turn use the address to retrieve the smart contract's ABI from blockchain network 102 via a new getABI API exposed by modified blockchain RPC interface 204 (steps (10) and (11); reference numerals 268 and 270). For simplicity, the replica-side operations for processing this getABI API are omitted from the figure. Finally, modified blockchain library 210 can construct appropriate calls to modified blockchain RPC interface 204 for invoking the smart contract's methods using the retrieved ABI (step (12); reference numeral 272).

With the improved workflow depicted in FIG. 2, a number of advantages are realized. First, because the smart contract address is signed by the replicas of blockchain network 102, end-user 112 can verify that this address is authentic using the network's corresponding public key and thereby overcome the security concerns arising out of sharing the address via an insecure communication mechanism. In some embodiments, rather than signing the address using a per-replica share of private key sk, each replica 104 may sign the address using a common private key and the blockchain network client can simply forward this signature to operator 108, rather than generating an aggregate signature.

Second, because the ABI of smart contract C is persisted on the blockchain along with the smart contract itself, there is no need for end-user 112 to store and manage it; instead, the end-user's dapp can directly retrieve the ABI from blockchain network 112 as needed (through, e.g., its blockchain library) using the getABI API mentioned above. Further, because all updates to the ABI will also be persisted to the blockchain, the dapp will automatically receive those updates upon retrieving the latest version of the ABI.

The remaining sections of this disclosure provide additional details for implementing the workflow shown in FIG. 2 according to various embodiments. It should be appreciated that FIG. 2 is illustrative and not intended to limit the embodiments presented herein. For example, although this figure depicts a particular arrangement of entities, other arrangements are possible (e.g., the functionality attributed to a particular entity may be split into multiple entities, entities may be combined, etc.). One of ordinary skill in the art will recognize other variations, modifications, and alternatives.

### 2. Smart Contract and ABI Deployment

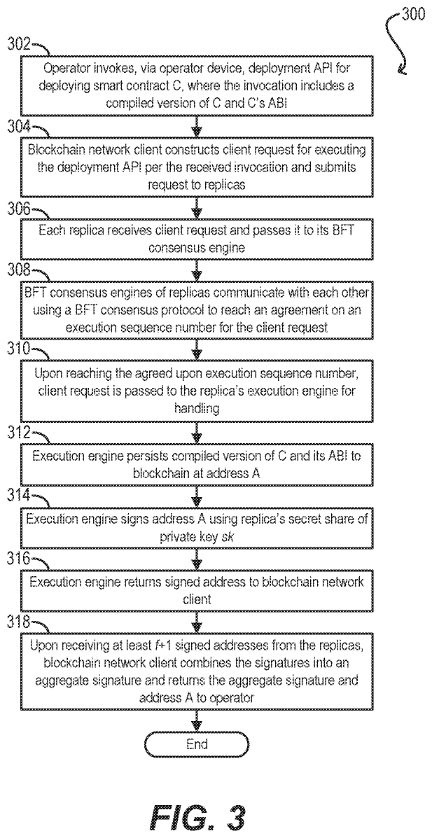

FIG. 3 depicts a flowchart 300 detailing the steps that may be performed in environment 200 for deploying smart contract C and its ABI on blockchain network 102 (per steps (1)-(7) of FIG. 2) according to certain embodiments.

Starting with block 302, operator 108 can invoke, using operator device 110, a deployment API of modified blockchain RPC interface 204 for deploying smart contract C, where this invocation includes the compiled code of the smart contract and its ABI. Upon receiving the invocation, modified blockchain network client 202 can construct a client request for executing the deployment API and can submit the request to replicas 104(1)-(N) of blockchain network 102 (block 304).

At block 306, each replica 104 can receive the client request and pass it to its BFT consensus engine 120. The BFT consensus engines can then agree upon an execution sequence number for the client request (block 308) and once this sequence number is reached, the request can be passed to the replica's modified execution engine 206 for handling (block 310).

At blocks 312 and 314, modified execution engine 206 can persist (i.e., store) both the compiled code for smart contract C and its ABI at address A on the replica's blockchain 124 and can sign address A using the replica's share skᵢ of private key sk. In certain embodiments, prior to signing the address, modified execution engine 206 can verify that the ABI is consistent with the smart contract code and can decline to sign the address if any inconsistency is found. In this way, modified execution engine 206's signature can indicate both the authenticity of the address and the correctness of the ABI located at that address. Modified execution engine 206 can subsequently return the signed address to modified blockchain network client 202 (block 316).

Finally, upon receiving at least f+1 signed addresses from the replicas, modified blockchain network client 202 can combine the signatures in the received addresses into an aggregate signature and can return address A and the aggregate signature to operator device 110/operator 108 (block 318).

### 3. Smart Contract Address Distribution and Verification

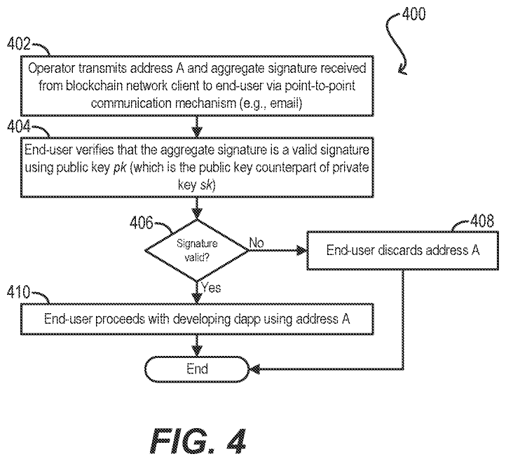

FIG. 4 depicts a flowchart 400 detailing the steps that may be performed in environment 200 for distributing address A for smart contract C to end-user 112 and verifying that this address is authentic (per steps (8) and (9) of FIG. 2) according to certain embodiments. Flowchart 400 assumes the smart contract and its ABI have been deployed on blockchain network 102 and operator 108 has received the address and aggregate signature in accordance with flowchart 300 of FIG. 3.

Starting with block 402, operator 108 can transmit to end-user 112 address A and the aggregate signature for A received from modified blockchain network client 202 via some point-to-point communication mechanism (e.g., email).

At block 404, end-user 112 can receive address A and the aggregate signature and can verify whether the address is authentic by validating aggregate signature using public key pk (i.e., the public key counterpart of the replicas' private key sk). This public key is assumed to be published in some manner and made available to end-user 112. If this signature validation fails (block 406), end-user 112 can discard the address (block 408) and the flowchart can end. However, if the signature validation succeeds, end-user 112 can proceed with developing modified dapp 208 using the address (block 410).

### 4. ABI Retrieval and Consumption

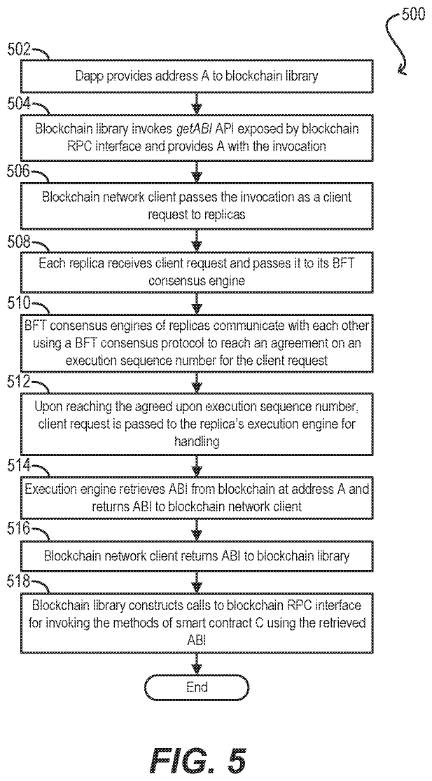

FIG. 5 depicts a flowchart 500 detailing the steps that may be performed in environment 200 for consuming, by modified dapp 208, the ABI for smart contract C (per steps (10)-(13) of FIG. 2) according to certain embodiments. Flowchart 500 assumes that modified dapp 208 has knowledge of the verified address A for smart contract C in accordance with flowchart 400 of FIG. 4.

Starting with block 502, modified dapp 208 can provide address A to modified blockchain library 210. In response, modified blockchain library 210 can invoke a getABI API exposed by modified blockchain RPC interface 204 to retrieve the ABI of smart contract C from blockchain network 102 using address A (block 504).

At block 506, modified blockchain network client 206 can pass the getABI API invocation as a client request to replicas 104(1)-(N) of blockchain network 102. At blocks 508 and 510, each replica 104 can pass the request to its BFT consensus engine 120 and the consensus engines can agree upon an execution sequence number for the request. Once this execution sequence number is reached, the request can be passed to the replica's modified execution engine 206 for handling (block 512).

At block 514, modified execution engine 206 can retrieve the ABI from the replica's blockchain 124 at address A and can return the ABI to modified blockchain network client 202. Client 202 can in turn return the ABI to modified blockchain library 210 (block 516).

Finally, at block 518, modified blockchain library 210 can construct calls to modified blockchain RPC interface 204 for invoking the methods of smart contract C using the retrieved ABI and the flowchart can end.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a replica in a set of N replicas that compose a blockchain network, a request to deploy a smart contract on a blockchain of the blockchain network, the request including a compiled version of the smart contract and an application binary interface (ABI) of the smart contract;
persisting, by the replica, the compiled version of the smart contract and the ABI at an address on the blockchain;
signing, by the replica, the address using a share of a private key of the blockchain network that is assigned to the replica, the share being known only to the replica and being unknown to other replicas in the set of N replicas; and
outputting, by the replica, the signed address.

2. The method of claim 1 wherein the blockchain network implements a Byzantine fault tolerant (BFT) consensus protocol that tolerates up to f faulty replicas, and wherein the shares of the private key assigned to the set of N replicas are generated using a (t, N) threshold signature scheme where t=f.

3. The method of claim 1 wherein the request originates from an operator of the blockchain network, and wherein a blockchain network client:
receives signed addresses from the set of N replicas;
combines signatures included in the signed addresses into an aggregate signature; and
sends the address and the aggregate signature to the operator.

4. The method of claim 3 wherein upon receiving the address and the aggregate signature from the blockchain network client, the operator transmits the address and the aggregate signature to an end-user developing an application.

5. The method of claim 4 wherein upon receiving the address and the aggregate signature from the operator, the end-user:
verifies that the aggregate signature is valid using a public key corresponding to the private key; and
programs the application using the address, thereby enabling the application to interact with the smart contract.

6. The method of claim 5 wherein upon being programmed using the address, the application provides the address to a blockchain library, and
wherein the blockchain library uses the address to invoke an application programming interface exposed by the blockchain network for retrieving the ABI from the blockchain.

7. The method of claim 1 wherein prior to signing the address, the replica verifies that the compiled version of the smart contract is consistent with the ABI.

8. A non-transitory computer readable storage medium having stored thereon program code executable by a replica in a set of N replicas that compose a blockchain network, the method comprising:
receiving, by the replica, a request to deploy a smart contract on a blockchain of the blockchain network, the request including a compiled version of the smart contract and an application binary interface (ABI) of the smart contract;
persisting, by the replica, the compiled version of the smart contract and the ABI at an address on the blockchain;
signing, by the replica, the address using a share of a private key of the blockchain network that is assigned to the replica, the share being known only to the replica and being unknown to other replicas in the set of N replicas; and
outputting, by the replica, the signed address.

9. The non-transitory computer readable storage medium of claim 8 wherein the blockchain network implements a Byzantine fault tolerant (BFT) consensus protocol that tolerates up to f faulty replicas, and wherein the shares of the private key assigned to the set of N replicas are generated using a (t, N) threshold signature scheme where t=f.

10. The non-transitory computer readable storage medium of claim 8 wherein the request originates from an operator of the blockchain network, and wherein a blockchain network client:
receives signed addresses from the set of N replicas;
combines signatures included in the signed addresses into an aggregate signature; and
sends the address and the aggregate signature to the operator.

11. The non-transitory computer readable storage medium of claim 10 wherein upon receiving the address and the aggregate signature from the blockchain network client, the operator transmits the address and the aggregate signature to an end-user developing an application.

12. The non-transitory computer readable storage medium of claim 11 wherein upon receiving the address and the aggregate signature from the operator, the end-user:
verifies that the aggregate signature is valid using a public key corresponding to the private key; and
programs the application using the address, thereby enabling the application to interact with the smart contract.

13. The non-transitory computer readable storage medium of claim 12 wherein upon being programmed using the address, the application provides the address to a blockchain library, and
wherein the blockchain library uses the address to invoke an application programming interface exposed by the blockchain network for retrieving the ABI from the blockchain.

14. The non-transitory computer readable storage medium of claim 8 wherein prior to signing the address, the replica verifies that the compiled version of the smart contract is consistent with the ABI.

15. A computer system acting as a replica in a set of N replicas that compose a blockchain network, the computer system comprising:
a processor;
a blockchain; and
a non-transitory computer readable medium having stored thereon program code that, when executed, causes the processor to:
receive a request to deploy a smart contract on the blockchain, the request including a compiled version of the smart contract and an application binary interface (ABI) of the smart contract;
persist the compiled version of the smart contract and the ABI at an address on the blockchain;
sign the address using a share of a private key of the blockchain network that is assigned to the replica, the share being known only to the replica and being unknown to other replicas in the set of N replicas; and
output the signed address.

16. The computer system of claim 15 wherein the blockchain network implements a Byzantine fault tolerant (BFT) consensus protocol that tolerates up to f faulty replicas, and wherein the shares of the private key assigned to the set of N replicas are generated using a (t, N) threshold signature scheme where t=f.

17. The computer system of claim 15 wherein the request originates from an operator of the blockchain network, and wherein a blockchain network client:
receives signed addresses from the set of N replicas;
combines signatures included in the signed addresses into an aggregate signature; and
sends the address and the aggregate signature to the operator.

18. The computer system of claim 17 wherein upon receiving the address and the aggregate signature from the blockchain network client, the operator transmits the address and the aggregate signature to an end-user developing an application.

19. The computer system of claim 18 wherein upon receiving the address and the aggregate signature from the operator, the end-user:
verifies that the aggregate signature is valid using a public key corresponding to the private key; and
programs the application using the address, thereby enabling the application to interact with the smart contract.

20. The computer system of claim 19 wherein upon being programmed using the address, the application provides the address to a blockchain library, and
wherein the blockchain library uses the address to invoke an application programming interface exposed by the blockchain network for retrieving the ABI from the blockchain.

21. The computer system of claim 20 wherein prior to signing the address, the replica verifies that the compiled version of the smart contract is consistent with the ABI.
